(19) United States
(12) Patent Application Publication
(10) Pub. No.: US 2026/0271099 A1
(43) Pub. Date: Sep. 10, 2026

(54) NETWORK COMMUNICATION DEVICE, SERVER DEVICE, NETWORK COMMUNICATION SYSTEM, AND NETWORK COMMUNICATION METHOD USING THE SAME

(71) Applicants: Sernet (Suzhou) Technologies Corporation, Jiangsu (CN); Sercomm Corporation, Taipei City (TW)

(72) Inventor: BaoFeng TANG, Jiangsu (CN)

(21) Appl. No.: 19/449,896

(22) Filed: Jan. 15, 2026

(30) Foreign Application Priority Data
Mar. 10, 2025 (CN) 202510274228.8

(51) Int. Cl. H04W 76/10

(52) U.S. Cl. CPC H04W 76/10

(57) ABSTRACT

The network communication device includes a first network communication unit, a second network communication unit, and a processor. The first network communication unit is used to establish a first connection and obtain a first Internet Protocol (IP) address through the first connection. The second network communication unit is used to establish a second connection and obtain a second IP address through the second connection. The processor is electrically connected to the first and second network communication units and is used to determine whether the first connection is disconnected and, if the first connection is disconnected, switch the communication path from the first connection to the second connection. The first IP address and the second IP address are the same.

### CROSS-REFERENCE TO RELATED APPLICATION

This application claims the benefit of People’s Republic of China application Serial No. 202510274228.8, filed on Mar. 10, 2025, the subject matter of which is incorporated herein by reference.

### BACKGROUND OF THE INVENTION

### Field of the Invention

The invention relates in general to a network communication device, a server device, a network communication system and a network communication method using the same.

### Description of the Related Art

A network communication device typically communicate with a cloud via its main port. When the main port of the network communication device disconnects with the cloud, the network communication device will be unable to communicate with the cloud. Therefore, designing a network communication device to resolve this existing problem is one of the goals of those working in this field.

### SUMMARY OF THE INVENTION

According to an embodiment of the present invention, a network communication device is provided. The network communication device includes a first network communication unit, a second network communication unit and a processor. The first network communication unit is configured to establish a first connection and obtain a first Internet Protocol (IP) address through the first connection. The second network communication unit is configured to establish a second connection and obtain a second IP address through the second connection. The processor is electrically connected to the first network communication unit and the second network communication unit and configured to determine whether the first connection is disconnected and if the first connection is disconnected, switch a communication path from the first connection to the second connection. The first IP address and the second IP address are the same.

According to another embodiment of the present invention, a server device is provided. The server device includes a first server and a second server. The first server is configured to assign a first IP address to a first network communication unit of a network communication device. The second server is configured to assign a second IP address to a second network communication unit of the network communication device. The first IP address and the second IP address are the same.

According to another embodiment of the present invention, a network communication system is provided. The network communication system includes a network communication device and a server device. The network communication device includes a first network communication unit, a second network communication unit and a processor. The first network communication unit is configured to establish a first connection and obtain a first Internet Protocol (IP) address through the first connection. The second network communication unit is configured to establish a second connection and obtain a second IP address through the second connection. The processor is electrically connected to the first network communication unit and the second network communication unit and configured to determine whether the first connection is disconnected and if the first connection is disconnected, switch a communication path from the first connection to the second connection. The server device includes a first server and a second server. The first server is configured to assign the first IP address to the first network communication unit of the network communication device through the first connection. The second server is configured to assign the second IP address to the second network communication unit of the network communication device through the second connection. The first IP address and the second IP address are the same.

According to another embodiment of the present invention, a network communication method is provided. The network communication method includes the following steps: establishing, by a first network communication unit, a first connection; establishing, by a second network communication unit, a second connection; obtaining, by the first network communication unit, a first IP address through the first connection; obtaining, by the second network communication unit, a second IP address through the second connection, wherein the first IP address and the second IP address are the same; determining, by a processor, whether the first connection is disconnected; and if the first connection is disconnected, switching, by the processor, the communication path from the first connection to the second connection.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1A illustrates a functional block diagram of a network communication system according to an embodiment of the present invention;

FIG. 1B illustrates a schematic diagram of a first connection of the network communication system in FIG. 1A being disconnected; and

FIG. 2 illustrates a flowchart of a network communication method of the network communication system in FIG. 1A.

### DETAILED DESCRIPTION OF THE INVENTION

The structural and working principles of the present invention will be described in detail below with reference to the accompanying drawings.

Variations of the present invention will be described in detail below, with illustrations provided. In addition to these detailed descriptions, the present invention may be widely implemented in other embodiments. Any simple substitution, modification or equivalent change to the described embodiments are included within the scope of the present invention. In the description of the specification, many specific details and implementation examples are provided to provide the reader a more complete understanding of the present invention; however, these specific details and implementation examples should not be considered as limitations of the present invention. Furthermore, well-known steps or elements are not described in the details to avoid unnecessary limitations on the present invention.

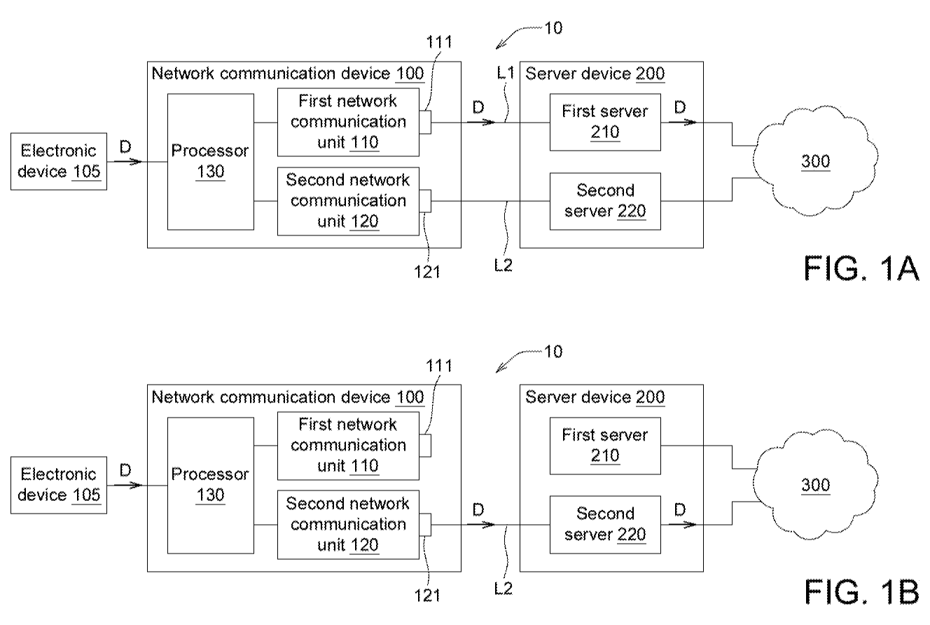

Referring to FIGS. 1A and 1B, FIG. 1A illustrates a functional block diagram of a network communication system 10 according to an embodiment of the present invention, and FIG. 1B illustrates a schematic diagram of a first connection L1 of the network communication system 10 in FIG. 1A being disconnected.

As shown in FIGS. 1A and 1B, the network communication system 10 includes the network communication device 100 and a server device 200. Data D from the electronic device 105 may be uploaded to an Internet 300 through the network communication device 100 and the server device 200. In addition, the data from the Internet 300 may also be downloaded to the electronic device 105 through the server device 200 and the network communication device 100.

As shown in FIGS. 1A and 1B, the electronic device 105 is, for example, a notebook computer, a smartphone, a tablet computer, a home appliance, a desktop computer or any other electronic device capable of communicating with the network communication device 100. The network communication device 100 is, for example, a modem, a gateway, a router, a set-top box, or any other electronic device capable of providing network communication. The network communication device 100 may be disposed in, for example, a user's activity space (e.g., home, office, etc.), while the server device 200 may be disposed in, for example, a server room of a telecommunications service provider (e.g., a telecommunications company).

As shown in FIGS. 1A and 1B, the network communication device 100 includes a first network communication unit 110, a second network communication unit 120 and a processor 130. The first network communication unit 110 is configured to establish the first connection L1 and obtain a first Internet Protocol (IP) address through the first connection L1. The second network communication unit 120 is configured to establish a second connection L2 and obtain a second IP address through the second connection L2. The processor 130 is electrically connected to the first network communication unit 110 and the second network communication unit 120 and is configured to determine whether the first connection L1 is disconnected (e.g., due to network communication unit failure or any other software and/or hardware failure) and switch the communication path from the first connection L1 to the second connection L2 if the first connection L1 is disconnected (as shown in FIG. 1B). In an embodiment, the first IP address and the second IP address are the same, and accordingly it reduces a delay time of switching the communication path from the first connection L1 to the second connection L2, making the switching process smoother and almost imperceptible to the user.

In another embodiment, the processor 130 is configured to determine whether the second connection L2 is disconnected and switch the communication path from the second connection L2 to the first connection L1 if the second connection L2 is disconnected.

Furthermore, the network communication device 100 communicates with the server device 200 using one of the first connection L1 and the second connection L2. When the one of the first connection L1 and the second connection L2 is disconnected, the network communication device 100 switches the communication path from the one of the first connection L1 and the second connection L2 to the other of the first connection L1 and the second connection L2. Due to the first IP address and the second IP address are the same, the delay time for switching communication path may be reduced, making the switching process smoother, and the user may hardly feel the communication path switching.

As shown in FIGS. 1A and 1B, the first network communication unit 110 supports, for example, one of a wired network and a wireless network, while the second network communication unit 120 supports, for example, the other of the wired network and the wireless network. The wired network includes, for example, fiber optic, Ethernet, Digital Subscriber Line (DSL), Data Service Interface Standard (DOCSIS) or other type of wired communication technology, while the wireless network includes, for example, 5th-Generation Mobile Communication Technology (5G), Wi-Fi or other type of the wireless communication technology.

In an embodiment, the first network communication unit 110 is, for example, a network interface card (NIC) which at least includes a first network part 111, and the second network communication unit 120 is, for example, a NIC, which includes at least a second network part 121. The network communication device 100 uses one of the first network part 111 and the second network part 121 as the primary network port (e.g., a preset network part) and uses the other of the first network part 111 and the second network part 121 as a backup network part. In the present embodiment, the first network part 111 is, for example, the primary network part, and the second network part 121 is, for example, the backup network part. When the primary network port is functional (e.g., communication is normal), the network communication device 100 uses the primary network port to access the Internet 300. When the primary network port is unfunctional (e.g., communication is disconnected or interrupted), the network communication device 100 may use a backup network port to access the Internet 300.

In an embodiment, the primary network port and the backup network port belong to different networks. However, since the first IP address and the second IP address are the same in the present embodiment, the delay time of the communication path switching from the first connection L1 to the second connection L2 may be reduced, making the switching process smoother and almost imperceptible to the user.

In addition, the processor 130 is, for example, a physical circuit formed using at least one semiconductor process.

As shown in FIGS. 1A and 1B, the server device 200 includes a first server 210 and a second server 220. The aforementioned first network communication unit 110 is further configured to establish the first connection L1 with the first server 210 and obtain the first IP address from the first server 210 through the first connection L1. The aforementioned second network communication unit 120 is further configured to establish the second connection L2 with the second server 220 and obtain the second IP address from the second server 220 through the second connection L2.

As shown in FIGS. 1A and 1B, the first server 210 is configured to assign the first IP address to the first network communication unit 110 of the network communication device 100. The second server 220 is configured to assign the second IP address to the second network communication unit 120 of the network communication device 100. In an embodiment, the first server 210 and the second server 220 may also be integrated into a single (or the same) server.

In some embodiments, when the first server 210 receives an IP address request signal from the first network communication unit 110, the first server 210 assigns the first IP address to the first network communication unit 110. When the second server 220 receives the IP address request signal from the second network communication unit 120, the second server 220 assigns the second IP address to the second network communication unit 120, wherein the first IP address and the second IP address are the same.

In some embodiments, when the first server 210 receives the IP address request signal from the first network communication unit 110, the first server 210 records the first identification code of the first network communication unit 110 (e.g., transmitted by the first network communication unit 110). When the second server 220 receives the IP address request signal from the second network communication unit 120, the second server 220 records a second identification code of the second network communication unit 120 (e.g., transmitted by the second network communication unit 120). The first server 210 and the second server 220 may communicate through the wireless technology or the wired communication technology. After confirming that the first identification code and the second identification code belong to the same network communication device 100, the first server 210 and the second server 220 respectively assign the same IP address to the first network communication unit 110 and the second network communication unit 120. In an embodiment, the first server 210 and the second server 220 may be electrically connected by using the wired communication technology or the wireless communication technology, and/or the first server 210 and the second server 220 may communicate by using any suitable and/or known communication protocol.

In addition, the identification code in this document may be, for example, the MAC address (Media Access Control address) of a network communication unit, or a preset string of numbers (e.g., binary, decimal, hexadecimal, etc.).

In some embodiments, the pairing relationship (e.g., a table) between the first identification code and the second identification code may be recorded or stored in the first server 210 and the second server 220. As a result, when the first server 210 receives the first identification code and the second server 220 receives the second identification code, the first server 210 and the second server 220 determine, based on the pairing relationship, that the first identification code and the second identification code belong to the same network communication device, and accordingly assign the same IP address to the first network communication unit 110 and the second network communication unit 120.

In some embodiments, the first server 210 and the second server 220 are integrated into a single server. When the single server receives the IP address request signal from the first network communication unit 110, the single server records the first identification code of the first network communication unit 110 (for example, the first identification code is transmitted by the first network communication unit 110). When the single server receives the IP address request signal from the second network communication unit 120, the single server records the second identification code of the second network communication unit 120 (for example, the second identification code is transmitted by the second network communication unit 120). After the single server confirms that the first identification code and the second identification code belong to the same network communication device 100, the single server assigns the same IP address to both the first network communication unit 110 and the second network communication unit 120.

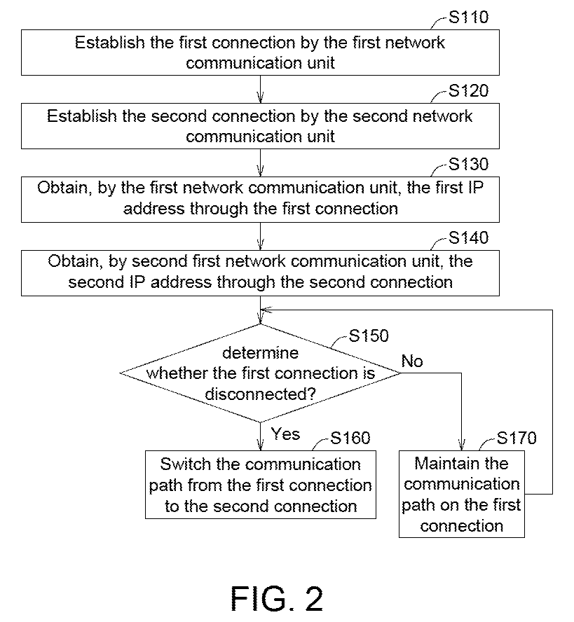

Referring to FIG. 2, FIG. 2 illustrates a flowchart of a network communication method of the network communication system 10 in FIG. 1A.

In step S110, as shown in FIG. 1A, the first network communication unit 110 establishes the first connection L1. For example, the first network communication unit 110 and the first server 210 may establish the first connection L1 using a suitable communication protocol. As long as the first network communication unit 110 and the first server 210 may establish the first connection L1, this embodiment of the invention does not limit the type of connection communication protocol used, and it may be any suitable and/or known connection communication protocol.

In step S120, as shown in FIG. 1A, the second network communication unit 120 establishes the second connection L2. For example, the second network communication unit 120 and the second server 220 may establish the second connection L2 using the suitable communication protocol. As long as the second network communication unit 120 and the second server 220 may establish the second connection L2, this embodiment of the invention does not limit the type of connection communication protocol used, and it may be any suitable and/or known connection communication protocol.

In step S130, the first network communication unit 110 may obtain the first IP address through the first connection L1. For example, the first network communication unit 110 may transmit the first identification code to the first server 210.

In step S140, the second network communication unit 120 may obtain the second IP address through the second connection L2. For example, the second network communication unit 120 may transmit the second identification code to the second server 220.

In an embodiment, before steps S130 and S140, the first server 210 and the second server 220 may communicate in advance to determine whether the first identification code and the second identification code belong to the same network communication device; if so, the first server 210 and the second server 220 respectively assign the same IP address to the first network communication unit 110 and the second network communication unit 120.

In step S150, the processor 130 determines whether the first connection L1 is disconnected. If so, the process proceeds to step S160; if not, the process proceeds to step S170.

In step S160, if the first connection L1 is disconnected, the processor 130 switches the communication path from the first connection L1 to the second connection L2. Due to the first IP address and the second IP address being the same, the delay time of switching the communication path from the first connection L1 to the second connection L2 may be reduced, making the switching process smoother, and the user may hardly feel the communication path switching.

In step S170, if the first connection L1 is not disconnected (i.e., normally connected), the processor 130 maintains the communication path on the first connection L1. Then, the process returns to step S150 to continuously determine (or detect) whether the first connection L1 is disconnected.

In summary, this invention provides a network communication device, a server device, a network communication system and a network communication method using the same. The network communication device may establish at least two connections with the server device, and uses one of the at least two connections as the communication path. When one of these connections is disconnected, the network communication device uses the other of the at least two connections as the communication path. In an embodiment, only one of the at least two connections is used as the communication path, while the other of the at least two connections is used as a backup path, wherein when the only one of the at least two connections is disconnected, the other of the at least two connections is used as the communication path. In an embodiment, due to the at least two connections use the same IP address, the delay time for switching communication paths may be reduced, making the switching process smoother, and the user may hardly perceive the communication path switching.

While the invention has been described by way of example and in terms of the preferred embodiment (s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A network communication device, comprising:
a first network communication unit, configured to:
establish a first connection; and
obtain a first Internet Protocol (IP) address through the first connection;
a second network communication unit, configured to:
establish a second connection; and
obtain a second IP address through the second connection;
and
a processor, electrically connected to the first network communication unit and the second network communication unit and configured to:
determine whether the first connection is disconnected; and
if the first connection is disconnected, switch a communication path from the first connection to the second connection;
wherein the first IP address and the second IP address are the same.

2. The network communication device according to claim 1, wherein the first network communication unit is further configured to:
establish the first connection with a first server; and
obtain the first IP address from the first server through the first connection.

3. The network communication device according to claim 1, wherein the second network communication unit is further configured to:
establish the second connection with a second server; and
obtain the second IP address from the second server through the second connection.

4. A server device, comprising:
a first server, configured to assign a first IP address to a first network communication unit of a network communication device; and
a second server, configured to assign a second IP address to a second network communication unit of the network communication device;
wherein the first IP address and the second IP address are the same.

5. The server device according to claim 4, wherein the first server and the second server are integrated into a single server.

6. A network communication system, comprising:
a network communication device, comprising:
a first network communication unit, configured to:
establish a first connection; and
obtain a first IP address through the first connection;
a second network communication unit, configured to:
establish a second connection; and
obtain a second IP address through the second connection; and
a processor, electrically connected to the first network communication unit and the second network communication unit and configured to:
determine whether the first connection is disconnected; and
if the first connection is disconnected, switch a communication path from the first connection to the second connection; and
a server device, comprising:
a first server, configured to:
assign the first IP address to the first network communication unit of the network communication device through the first connection;
a second server, configured to:
assign the second IP address to the second network communication unit of the network communication device through the second connection;
wherein the first IP address and the second IP address are the same.

7. The network communication system according to claim 6, wherein the first server and the second server are integrated into a single server.

8. A network communication method, comprising:
establishing, by a first network communication unit, a first connection;
establishing, by a second network communication unit, a second connection;
obtaining, by the first network communication unit, a first IP address through the first connection;
obtaining, by the second network communication unit, a second IP address through the second connection, wherein the first IP address and the second IP address are the same;
determining, by a processor, whether the first connection is disconnected;
if the first connection is disconnected, switching, by the processor, a communication path from the first connection to the second connection.

9. The network communication method according to claim 8, comprising:
establishing the first connection by the first network communication unit and a first server; and
obtaining, by the first network communication unit, the first IP address from the first server through the first connection.

10. The network communication method according to claim 9, comprising:
establishing the second connection by second first network communication unit and a second server; and
obtaining, by the second network communication unit, the second IP address from the second server through the second connection.
